(19) United States
(12) Patent Application Publication
(10) Pub. No.: US 2015/0176800 A1
(43) Pub. Date: Jun. 25, 2015

(54) SUPPORTING BASE FOR SEMICONDUCTOR CHIP

(71) Applicant: I-CHIUN PRECISION INDUSTRY CO., LTD., New Taipei City (TW)

(72) Inventors: CHIEN-YU CHEN, New Taipei City (TW); CHING-AN WU, New Taipei City (TW)

(73) Assignee: I-CHIUN PRECISION INDUSTRY CO., LTD., New Taipei City (TW)

(21) Appl. No.: 14/140,509

(22) Filed: Dec. 25, 2013

(51) Int. Cl. F21V 7/00

(52) U.S. Cl. CPC F21V 7/00

(57) ABSTRACT

A supporting base for a semiconductor chip comprises a substrate, a surrounding wall and a reflection plate. The surrounding wall is formed on the substrate, and an accommodating space is formed between the surrounding wall and the substrate and is provided for receiving the semiconductor chip therein. The semiconductor chip is electrically connected to the substrate. The surrounding wall includes a cut-out portion on one side thereof. The reflection plate is extend to be bent from the substrate, and the reflection plate is configured to correspond to the cut-out portion and the semiconductor and is formed of an obtuse angle with the substrate. Therefore, with such structure, the present invention is able to achieve the effect of an increased illumination range.

### BACKGROUND OF THE INVENTION

1. Field of the Invention

The present invention is related to a semiconductor component, in particular, to a supporting base for a semiconductor chip.

2. Description of Related Art

During the use of a semiconductor component, it is often required to install a semiconductor chip onto a supporting based that is specially designed therefor and to connect a circuit board electrically via the supporting base in order to properly mount the semiconductor chip on the circuit board. The semiconductor chip can be a light emitting diode or an infrared chip, which is mainly used in a lighting fixture or an infrared sensor.

Since the light emitted by the semiconductor chip has directions and fixed illumination angles, if the semiconductor chip is the light emitting diode, the situation of non-uniform distribution of light would occur, and the situation of improper sensing would occur if the semiconductor chip is the infrared chip; therefore, there is a need for an improvement to increase the range of the light emitted by the semiconductor chip.

### SUMMARY OF THE INVENTION

The present invention is to provide a supporting base for a semiconductor chip, which utilizes a reflection plate configured to correspond with a cut-out portion and the semiconductor chip in order to allow the light emitted from the semiconductor chip to be reflected by the reflection plate such that the effect of increased illumination range can be achieved.

Accordingly, the present invention provides a supporting base for a semiconductor chip, comprising a substrate, a surrounding wall and a reflection plate; the surrounding wall is formed on the substrate; an accommodating space is formed between the surrounding wall and the substrate, and is provided for receiving the semiconductor chip therein; the semiconductor chip is electrically connected to the substrate; the surrounding wall has one side formed of an cut-out portion; the reflection plate is arched from the substrate and formed within the cut-out portion; the reflection plate is configured to correspond with the semiconductor chip and is formed of an obtuse angle 31 with the substrate.

The present invention also includes the following effects. First, the design of attaching the semiconductor to the heat dissipating portion is able to achieve the effect of heat dissipation of the semiconductor chip; second, by attaching each one of the first arched surfaces to each one of the second arched surfaces correspondingly, the insulation member and the metal board member can be of greater attachment strength.

### BRIEF DESCRIPTION OF DRAWING

FIG. 1 is a perspective view showing the outer appearance of the present invention;

FIG. 2 is a bottom view of the present invention;

FIG. 3 is a top view of the present invention with a semiconductor attached thereto;

FIG. 4 is a cross sectional view showing a state of use according to the present invention;

FIG. 5 is a perspective view of the formation of the metal board member being manufactured; and

FIG. 6 is a top view of another embodiment according to the present invention.

### DETAILED DESCRIPTION OF THE INVENTION

The following provides detailed description of embodiments of the present invention along with the accompanied drawings. It can, however, be understood that the accompanied drawings are provided for illustrative purposes only and shall not be treated as limitations to the present invention.

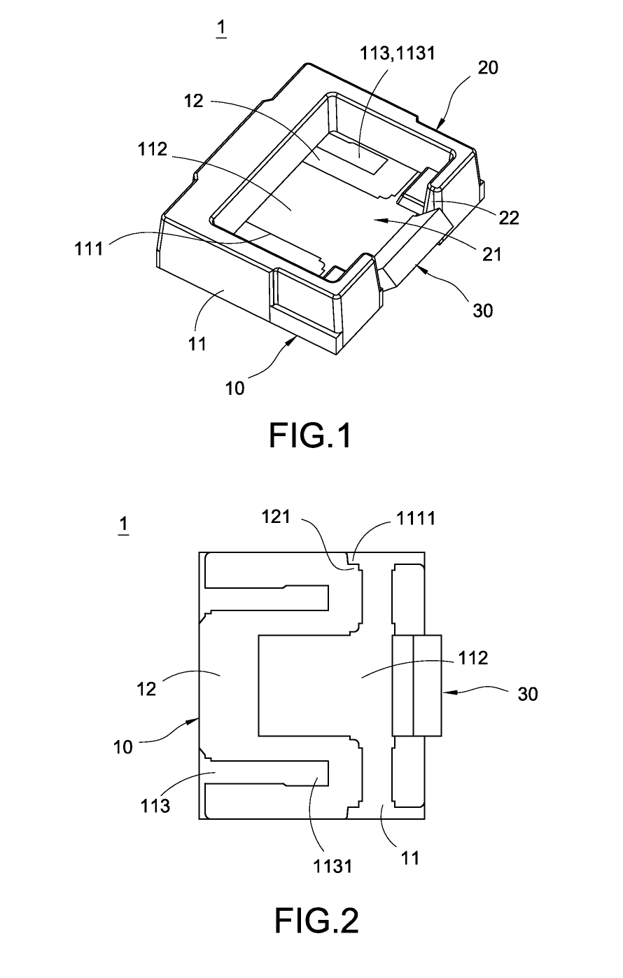

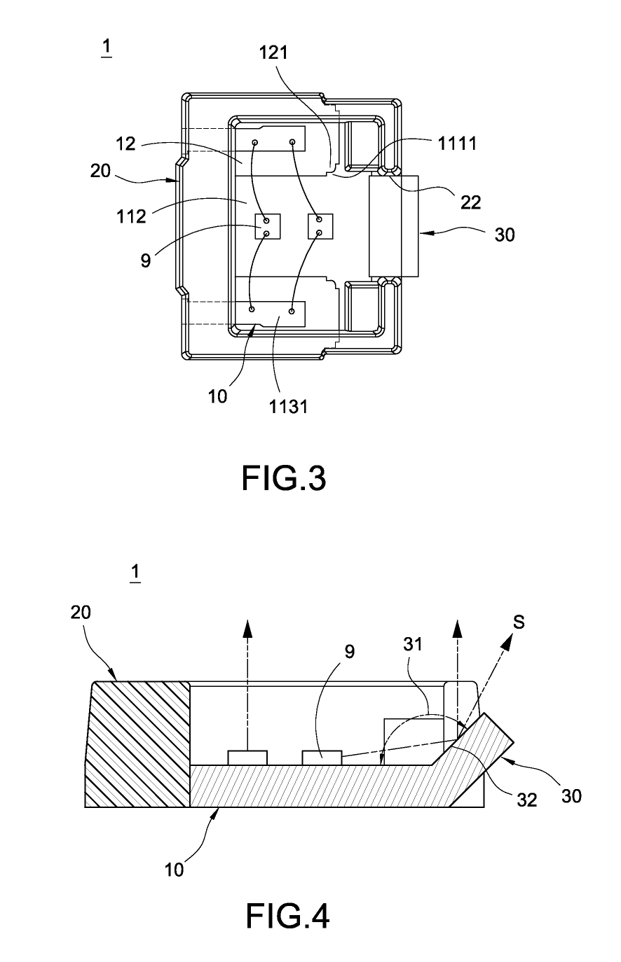

Please refer to FIGS. 1 to 3. As shown in the figures, the present invention provides a supporting base 1 for a semiconductor chip, comprising a substrate 10, a surrounding wall 20 and a reflection plate 30.

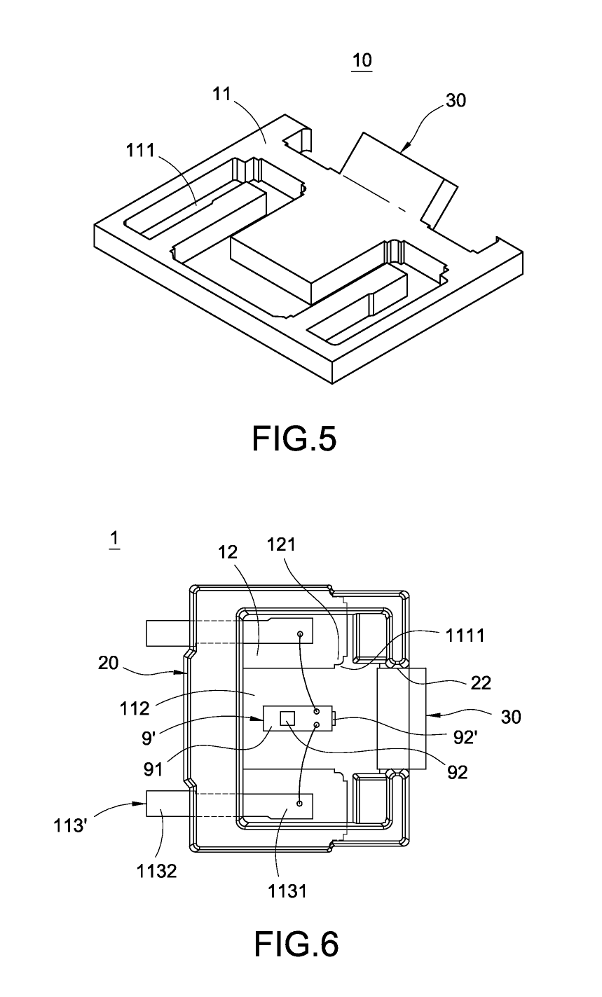

The substrate 10 comprises a metal board member 11 and an insulation member 12. The metal board member 11 includes an opening slot 111 (as shown in FIG. 5); the insulation member 12 is fixed within the opening slot 111 and divides the metal board member 11 into a heat dissipating portion 112 and a conductive portion 113. The opening slot 111 and the insulation member 12 are of a W-resembling shape. The opening slot 111 includes an inner wall having a plurality of different first corner surfaces 1111; the insulation member 12 includes an outer circumferential surface having a plurality of different second corner surfaces 121; each second corner surface 121 is firmly attached to each corresponding first corner surface 111. In addition, the insulation member 12 is an insulation plastic unit.

The surrounding wall 20 is formed on the substrate 10. An accommodating space 21 is formed between the surrounding wall 20 and the substrate 10 and, is provided for receiving a semiconductor chip 9 therein. The surrounding wall 20 can be formed on the metal board member 11 by an injection molding process and can be of the same material as the insulation member 12. The heat dissipating portion 112 and a part of the conductive portion 113 are exposed in the accommodating space 21; the surrounding wall 20 and the insulation member 12 separate the conductive portion 113 in the accommodating space 21 into a plurality of electrodes 1131. The semiconductor 9 is attached to the heat dissipating portion 112 and electrically connected to the electrodes 1131. The surrounding wall 20 includes a cut-out portion 22 formed on one side of the heat dissipating portion 112 away from the conductive portion 113.

The reflection plate 30 is extended to be bent from one end edge of the heat dissipating portion 112 at the cut-out portion 22; the reflection plate 30 is configured to correspond with the cut-out portion 22 and the semiconductor chip 9. An obtuse angle 31 is formed between the reflection plate 30 and the substrate 10. The obtuse angle 31 is of an angle between 91 degrees and 179 degrees and preferably between 110 degrees and 160 degrees. The reflection board 30 includes a surface facing to the accommodating space 21 and coated with a reflection coating layer 32.

Please refer to FIG. 4. As shown in the figure, first, a plurality of semiconductor chips 9 are installed within the accommodating space 21 of the surrounding wall 91 and are thermally attached to the heat dissipating portion 112 of the metal board member 11. In addition, a plurality of conductive wires 91 are used to electrically connect the plurality of semiconductor chips 9 with each one of the electrodes 1131; wherein each one of the semiconductor chips 9 can be a light emitting diode or an infrared chip and etc. When the semiconductor chips 9 are driven to emit light, the light S emitted by the semiconductor chip 9 can be reflected by the reflection coating layer 32 coated on the reflection plate 30 such that the illumination range of the light S emitted from the semiconductor chip 9 can be increased.

In addition, with the design of the opening slot 111 having the inner wall formed of the plurality of first corner surfaces 1111 and the insulation member 12 having the outer circumferential surface formed of the plurality of second corner surfaces 121 as well as the design of having the first corner surfaces 1111 correspondingly secured with the second corner surfaces 121, respectively, the unfavorable situation in which the insulation member 12 and the metal board member 11 disengage from each other due to external forces can be prevented.

Furthermore, with the design of attaching the semiconductors 9 to the heat dissipating portion 112, the heat dissipating portion 112 is able to absorb the heat generated by the semiconductor chips 9 and to conduct the heat to the environment in order to achieve the effect of heat dissipation for the semiconductor chips 9.

Please refer to FIG. 6. As shown in the figure, in addition the aforementioned embedment for the supporting base of the present invention, it can also be implemented differently in another embodiment; wherein the semiconductor chip 9′ comprises a conductive ceramic plate 91 and two chip units 92, 92′. The conductive ceramic plate 91 is generally of a rectangular elongated body, which includes a flat top surface and a flat front surface with the chip unit 92, 92′ attached thereon, respectively; wherein the chip unit 92′ at the front surface is configured to correspond to a location of the reflection plate 30 so that the reflection plate 30 can reflect the light emitted from the chip unit 92′. Also, the conductive portion 113′ of the metal board member 11 includes not only the aforementioned electrodes 1131 but also an insertion terminal 1132 extended from each electrode 1131 and protruded out of the surrounding wall 20 to engage with an insertion slot of a circuit board (not shown in the figure).

In view of the above, the supporting base for a semiconductor chip according to the present invention is of industrial applicability, novelty and inventive step. In addition, the structure of the present invention is not seen in any similar products nor being disclosed publically, which complies with the patentability requirement for the grant of patent right and is applied legitimately.

What is claimed is:

1. A supporting base 1 for a semiconductor chip, comprising:
a substrate (10);
a surrounding wall (20) formed on the substrate (10), an accommodating space (21) formed between the surrounding wall (20) and the substrate (10) and provided for receiving the semiconductor chip (9) therein, the semiconductor chip (9) electrically connected to the substrate (10), the surrounding wall (20) having one side formed of an cut-out portion (22); and
a reflection plate (30) extended to be bent from the substrate (10) and formed within the cut-out portion (22), the reflection plate (30) configured to correspond with the semiconductor chip (9) and formed of an obtuse angle (31) with the substrate (10).

2. The supporting base for a semiconductor chip according to claim 1, wherein the obtuse angle (31) is of an angle between 91 degrees and 179 degrees.

3. The supporting base for a semiconductor chip according to claim 2, wherein the obtuse angle (31) is of an angle between 110 degrees and 160 degrees.

4. The supporting base for a semiconductor chip according to claim 1, wherein the substrate (10) comprises a metal board member (11) and an insulation member (12); the metal board member (11) includes an opening slot (111); the insulation member (12) is fixed within the opening slot (111) and divides the metal board member (11) into a heat dissipating portion (112) and a conductive portion (113); the heat dissipating portion (112) and a part of the conductive portion (113) are exposed in the accommodating space (21); the semiconductor (9) is attached to the heat dissipating portion (112) and electrically connected to the conductive portion (113).

5. The supporting base for a semiconductor chip according to claim 4, wherein the surrounding wall (20) is fixed onto the metal board member (11) and the insulation member (12) the surrounding wall (20) and the insulation member (12) divide the conductive portion (113) within the accommodating space (21) into a plurality of electrodes (1131); the semiconductor (9) is electrically connected to each one of the electrodes (1131).

6. The supporting base for a semiconductor chip according to claim 5, wherein the conductive portion (113) includes an insertion terminal (1132) extended from each electrode (1131) and protruded out of the surrounding wall (20).

7. The supporting base for a semiconductor chip according to claim 4, wherein the cut-out portion (22) is at one side of the heat dissipating portion (112) away from the conductive portion (113); the reflection plate (30) is at one end of the heat dissipating portion (112) adjacent to the cut-out portion (22).

8. The supporting base for a semiconductor chip according to claim 4, wherein the opening slot (111) and the insulation member (12) are both of a W-resembling shape.

9. The supporting base for a semiconductor chip according to claim 8, wherein the opening slot (111) includes an inner wall having a plurality of first corner surfaces (1111); the insulation member (12) includes an outer circumferential surface having a plurality of second corner surfaces (121); each first corner surface (111) is firmly attached to each corresponding second corner surface (121).

10. The supporting base for a semiconductor chip according to claim 4, wherein the insulation member (12) is an insulation plastic unit.

11. The supporting base for a semiconductor chip according to claim 1, wherein the reflection board (30) includes a surface facing the accommodating space (21) and coated with a reflection coating layer (32).

12. The supporting base for a semiconductor chip according to claim 1, wherein the semiconductor chip (9′) comprises a conductive ceramic plate (91) and two chip units (92, 92′); the conductive ceramic plate (91) is a rectangular elongated body, and the rectangular elongated body includes a flat top surface and a flat front surface with the chip units (92) attached thereon, respectively; the chip unit (92) at the front surface is configured to correspond to a location of the reflection plate (30).
